(19) United States
(12) Patent Application Publication
(10) Pub. No.: US 2009/0283056 A1
(43) Pub. Date: Nov. 19, 2009

(54) GLOW-IN-THE-DARK ANIMAL COLLARS

(76) Inventor: John Mattera, East Setauket, NY (US)

Correspondence Address: The Law Office of Frank V. DeRosa, PC., 2005 Merrick Road, Suite 329, Merrick, NY, 11566, US

(21) Appl. No.: 12/120,187

(22) Filed: May 13, 2008

(51) Int. Cl. A01K 27/00

(52) U.S. Cl. 119/858

(57) ABSTRACT

Glow-in-the dark animal collars are provided, in which photoluminescence elements formed from thin flexible sheets or films with luminescent properties are secured to strap members of conventional animal collars with stitching patterns that prevent creasing, folding or delamination of the photoluminescent elements without having to use glue, adhesives, or epoxy materials.

### TECHNICAL FIELD

Embodiments of the invention generally relate to glow-in-the-dark animal collars and, more specifically, glow-in-the-dark animal collars that are designed with photoluminescent elements formed from thin flexible films or sheet material, which are secured to collar straps using stitching patterns that prevent the formation of bulging creases or folds in the photoluminescent elements.

### BACKGROUND

In general, various techniques have been proposed to equip animal collars with some type of illumination mechanism that allows an individual to locate and identify an animal donning the illuminated collar in dark or at dusk conditions. For instance, one conventional technique involves attaching light-reflecting elements to animal collars, such as disclosed in U.S. Pat. No. 3,871,336 to Bergman. This technique is disadvantageous in that animal collars with light-reflective elements will provide illumination only when external light is directed at and reflected by the light-reflective elements on the collar. In the absence of external light, however, the animal collar will not provide the illumination needed to locate, identify or otherwise detect the animal in the dark.

Other conventional techniques include equipping animal collars with light-generating elements such as small light bulbs, LEDs or optical fibers, together with appropriate circuitry and power sources to drive the light generating elements, such as disclosed in U.S. Pat. No. 7,140,327 to Morehead. Although such techniques provide constant illumination then the light-generating element are powered on, the ability to integrate active illumination circuitry with animal collars can be highly problematic due to complexity in design, and can be cost-prohibitive.

Other conventional methods to illuminate animal collars involve the use of glow in the dark materials such as applying a coat of photoluminescent paint to animal collars as described in U.S. Pat. No. 2,798,458 to Odermatt. Such techniques can be disadvantageous when the photoluminescent materials used do not provide sufficient brightness and/or tend to glow for a very short time, which quickly fades after being exposed to external light.

### SUMMARY OF THE INVENTION

Embodiments of the invention generally relate to glow-in-the-dark animal collars that are designed with photoluminescent elements formed from thin flexible films or sheet material, which are secured to straps of animal collars using stitching. The photoluminescent elements can be in the form of strips, patches, or other ornamental shapes that are cut or otherwise patterned from thin flexible phosphorescent films or sheet material such as photoluminescent vinyl. In accordance with exemplary embodiments of the invention, photoluminescent elements are stitchably secured to a collar strap using a stitching pattern that includes a perimeter stitch pattern and inner stitch pattern. The perimeter stitch pattern includes stitching lines that extend around a perimeter of the photoluminescent element. The inner stitching pattern includes a plurality of stitching lines that are formed over an inner region of the photoluminescent element bounded by the perimeter stitching lines.

In accordance with exemplary embodiments of the invention, stitching patterns serve to securely adhere the photoluminescent elements to the collar straps without the need for glue, adhesives, epoxy, or other similar types of bonding techniques, while preventing unwanted folding and creasing of the flexible material forming the photoluminescent elements due to stretching and flexing forces that are applied to the photoluminescent elements secured to the surface of the collar straps as the animal collar is repeatedly bent and stretched when placed around the animal neck. The use of stitching provides flexibility and ease in manufacturing as the photoluminescent elements can be readily secured to collar straps made of various types of material such as leather, nylon, plastic, without having to consider differences in material properties between the constituent materials forming the photoluminescent elements and collar straps, which would be necessary if only glue, adhesive or epoxy materials, for example, were used to bond the photoluminescent elements to the collar straps so as to ensure a sufficiently strong bonding interface that would be sufficient to prevent delaminating of the photoluminescent elements from the surface of the collar strap due to the stretching and flexing forces.

These and other exemplary embodiments, aspects, features and advantages of the present invention will become apparent from the following detailed description of exemplary embodiments that is to be read in connection with the accompanying drawings.

### BRIEF DESCRIPTION OF THE DRAWINGS

FIG. 1 is a schematic top plan view of an animal collar having a photoluminescent element secured to the animal collar by stitching, according to an exemplary embodiment of the invention.

FIGS. 2A, 2B and 2C illustrate exemplary stitching patterns to secure a photoluminescent element to a collar strap, according to exemplary embodiments of the invention.

FIG. 3 schematically depicts a multilayer flexible photoluminescent sheet material that can be used to form photoluminescent elements for stitching to animal collar straps, according to an exemplary embodiment of the invention.

FIG. 4 illustrates an exemplary arrangement of photoluminescent elements that can be stitchably secured to an animal collar, according to another exemplary embodiment of the invention.

FIG. 5 illustrates an exemplary photoluminescent element having a text pattern or marking that can be stitchably secured to an animal collar, according to an exemplary embodiment of the invention.

### DETAILED DESCRIPTION OF EXEMPLARY EMBODIMENTS

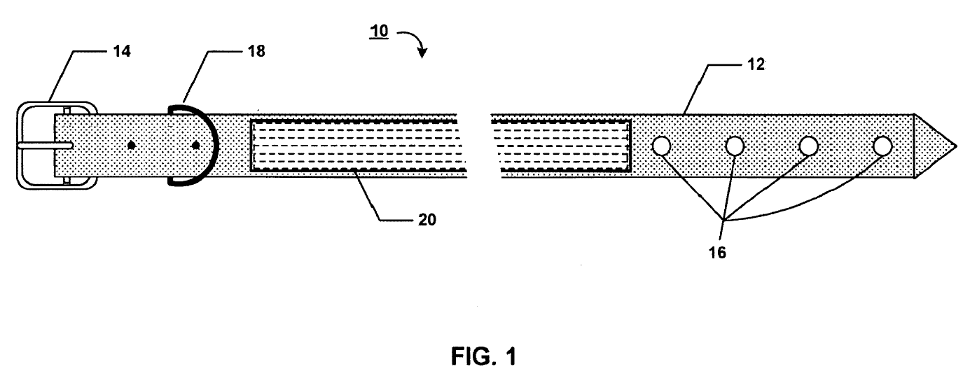

FIG. 1 is a schematic top plan view of an animal collar having a photoluminescent element secured to the animal collar by stitching, according to an exemplary embodiment of the invention. In particular, FIG. 1 illustrates an animal collar (10) (which is shown opened flat) which comprises an elongated strap member (12), a clasp (14) attached on a first end of the strap member(12), a plurality of through holes (16) formed on a second end portion of the strap member and (12) and a loop member (18). The strap member (12) may be formed of any type of material commonly used for animal collars such as leather, nylon, cloth, or other durable fabrics. The clasp (14) is configured to mateably engage the holes (16) to secure the animal collar around the neck of an animal and the loop (18) is provided to attach a leash to the animal collar (10).

As further shown in FIG. 1, a photoluminescent element (20) in the form of an elongated rectangular strip is stichably secured to the surface of the strap member (12) and extends along the length of the collar strap member (12) between the end regions of the strap (12). In general, the photoluminescent element (20) can be formed from thin, flexible films or sheet materials having luminescent properties, such as photoluminescent vinyl (as will be described in further detail below with reference to FIG. 4). Although FIG. 1 illustrates a photoluminescent element (20) in the form of a single, elongated strip, one or more photoluminescent elements can be cut or otherwise patterned from thin flexible photoluminescent film or sheet materials to form photoluminescent elements in the forms of patches, circles, ovals, stars, diamonds or other ornamental shapes that can be stitchably attached to the strap member (12) of a conventional animal collar.

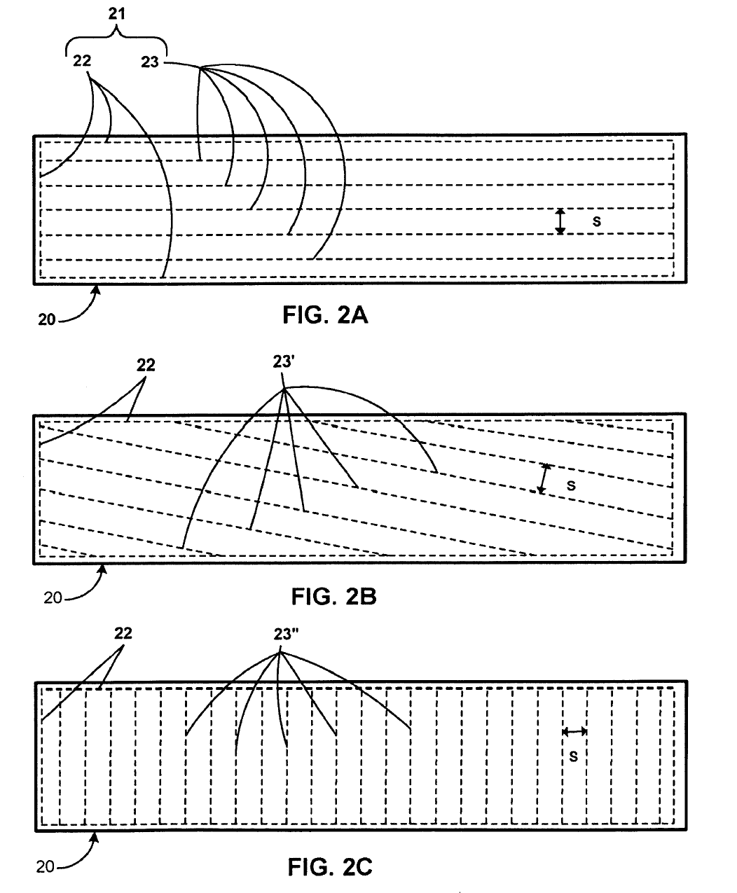

In accordance with exemplary embodiments of the invention, the photoluminescent element (20) is attached to the surface of the collar strap (12) by a pattern of stitching lines (which are depicted in FIG. 1 as dashed lines). FIG. 2A illustrates an exemplary stitching pattern (21) similar to that shown in FIG. 1 for stitchably securing the elongated strip-shaped photoluminescent element (20) to the collar strap (12). As depicted in FIG. 2A, the stitching pattern (21) includes a perimeter stitch pattern comprising perimeter stitching lines (22) that extend around a perimeter of the photoluminescent element (20) as well as an inner stitch pattern comprising a plurality of inner stitching lines (23) which extend in and over the inner surface region of the photoluminescent element (20) that is bounded by and located between the perimeter stitching lines (22).

In accordance with exemplary embodiments of the invention, photoluminescent elements formed from thin, flexible films or sheet materials are stitchably secured to animal collar straps via stitching patterns that eliminated the need for gluing, bonding, or other non-stitching attachment means. Advantageously, the use of stitching provides flexibility and ease in manufacturing as the photoluminescent elements can be readily secured to collar straps made of various types of material such as leather, nylon, plastic, with stitching in a universal manner. In contrast, when using glue, adhesive, epoxy or other non-stitching attachment methods, due consideration must be given to the differences in material properties between the constituent materials forming the photoluminescent elements and collar straps to ensure that the type of glue/adhesive/epoxy used is sufficient to provide sufficient bonding interface and prevent delaminating of the photoluminescent elements from the surface of the collar strap.

More specifically, irrespective of the manner in which photoluminescent elements are attached to the collar straps, due consideration must be given to the fact that the material forming the photoluminescent elements will be repeatedly stretched and flexed as the animal collar is manipulated from a flat orientation to annular orientation when wrapped around the neck of the animal. In this regard, when using non-stitching bonding methods, due consideration must be given to the type of glues, adhesives or epoxies, if any, that would be effective in providing a secure and durable bonding interface between the surface of the strap member (12) and the photoluminescent elements, and prevent delaminating of the photoluminescent elements due to stresses and strains applied at the bonding interface between the surface of the collar straps and photoluminescent element due to bending, stretching and flexing applied to the photoluminescent element as the animal collar is repeatedly bent and flexed during use.

Although the use of stitching can eliminate such considerations, it has been determined that certain stitching patterns in accordance with exemplary embodiments of the invention are significantly more effective in securing the flexible photoluminescent elements to the surface of the collar strap. For instance, it has been determined that stitching a photoluminescent element (such as a photo luminescent vinyl element) to the collar strap solely by use of perimeter stitching around the outer perimeter of the photo luminescent element is insufficient to maintain the photoluminescent element flat against the surface of the collar strap, and actually results in the formation of bulging creases and folds in the photoluminescent element caused by repeated stretching and flexing of the photoluminescent element material as the flexible collar is wrapped around the neck of the animal.

Indeed, when stitching photoluminescent elements to the external surface of the collar strap, the collar strap is disposed in a straight and flat position. When the collar is placed around the neck of an animal, the annular bending of the collar strap causes stretching of the photoluminescent element material stitched to the strap. When the photoluminescent material is only perimeter stitched to the collar strap, the stitching prevents or minimizes stretching of the flexible photoluminescent elements in the stitched perimeter region, while stretching occurs in the unstitched inner region of the photoluminescent element. Thus, perimeter stitching alone results in the formation of protruding folds and creases in the photoluminescent element material, where the photoluminescent material does not lay flat, planar and smooth against the surface of the collar strap.

To address these issues, it was determined that the formation of bulging creases or folds in the flexible photoluminescent element material can be eliminated by stitching the photoluminescent element to collar straps using stitching patterns that include perimeter stitching lines that extend around a perimeter of the photoluminescent element as well as a plurality of inner stitching lines that extend in the inner surface region of the photoluminescent element between the perimeter stitching lines. For instance, FIGS. 2A, 2B and 2C illustrate exemplary stitching patterns that can be used to secure a photoluminescent element to a collar strap, according to exemplary embodiments of the invention. In particular, FIGS. 2A˜2C schematically illustrate exemplary stitching patterns (21) that can be used to secure the elongated strip photoluminescent element (20) (FIG. 1) to the collar strap (12). As discussed above, FIG. 2A, illustrates a stitching pattern (21) comprising perimeter stitching (22) and a pattern of inner stitching lines (23). The inner stitching lines (23) form a pattern of parallel stitching lines that extend in a longitudinal (length) direction of the collar strap (12) within an interior region of the strip element (20) bounded by the perimeter stitching (22). As shown in FIG. 2A, the inner stitching lines (23) may be equally spaced apart by a distance “s”, although equal-distant spacing is not necessary for the inner stitching pattern, and the spacing “s” between the stitching lines 23 may vary over the pattern, depending on the decorative design that may be desired. However, as explained below, depending on the size and shape of the photoluminescent element, the spacing “s” should not exceed a certain amount between any adjacent stitching lines, or bulging folds or creases may form in the photoluminescent element material in the large space between the adjacent stitching lines.

In another exemplary embodiment of the invention as shown in FIG. 2B, the stitching pattern (21) in FIG. 2A is modified to include an inner pattern of inner stitching lines (23′) that form a pattern of parallel, equi-spaced stitching lines that extend over the inner region of photoluminescent strip element (20) between the perimeter stitching lines (22) and are oriented at an angle with respect to the longitudinal (length) direction of the elongated strap member (12). In another exemplary embodiment of the invention as shown in FIG. 2C, the stitching pattern (21) in FIG. 2A is modified to include an inner pattern of inner stitching lines (23″) that form a pattern of parallel, equi-spaced stitching lines that extend over the inner region of photoluminescent strip element (20) between the perimeter stitching lines (22) and are oriented transverse to the longitudinal (length) direction of the elongated strap member (12). As shown in FIGS. 2B and 2C, the inner stitching lines (23′) and (23″) may be equally spaced apart by a distance “s”, although equal-distant spacing is not necessary for the inner stitching pattern, and the spacing “s” between the stitching lines 23 may vary over the pattern, depending on the decorative design that may be desired.

In the exemplary embodiments of FIG. 2A˜2C, the spacing “s” between adjacent inner stitching lines (23), (23′) and (23″) is selected to ensure that the stitching patterns illustrated in FIGS. 2A˜2C are effective to prevent creasing and folding of the sheet material forming the strip element (20) due to stretching of the photoluminescent element (20) in the longitudinal direction along the collar strap as the collar strap is bent and flexed around the neck of an animal. In one exemplary embodiment of the invention, the amount of spacing “s” between the parallel inner stitch lines can range from about 3/16″ to about 1/16″, depending on the size and shape of the photoluminescent elements. Indeed, depending on the shape and size of the photoluminescent element, when the spacing between the inner stitching lines is too large. protruding creases or folds may be formed in the material within the spaces between the inner stitching lines due to stretching. The amount of stretching of the photoluminescent element in the longitudinal length direction of the collar will vary depending on the size of the element in such direction. For example, short strips of photoluminescent elements may not be subjected to as much stretching forces as longer lengths of strip elements, so larger stitch line spacing “s” may be applied.

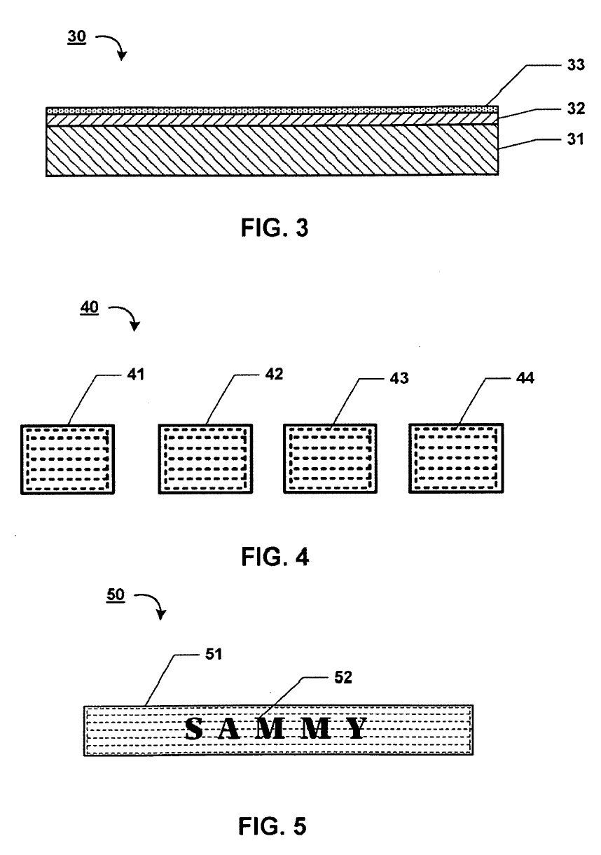

It is to be understood that the stitching patterns is depicted in FIGS. 2A˜2C are merely exemplary patterns that may be used to effectively secure flexible photoluminescent elements and prevent creasing and folding of the flexible material forming the photoluminescent element. Various stitching patterns according to exemplary embodiments of the invention may be formed as desired to provide a decorative stitching pattern to enhance the decorative aspect of the collar features to the collars, while providing secured stitching to prevent creasing or folding of the photoluminescent element material due to repeated stretching forces applied to the elements in the direction along the length of the collar strap. Moreover, regardless of the density of the stitching lines forming the inner stitch pattern (wherein the stitch line density increases as “s” decreases), when the stitching lines are made of relatively thin threading with light coloring (or matching coloring of the photoluminescent element), the stitching pattern is not readily visible in the background of the glow that radiates from the photoluminescent element. However, for decorative purposes, the stitching line patterns can be formed in a way (thick or densely spaced) that the stitching lines cover the glowing layer so as to be visible in the glowing background of the photoluminescent element so as to provide some decorative marking or pattern that is visible. FIG. 3 is a schematic side view of various layers of flexible photoluminescent film or sheet material (30) which may be used in accordance with exemplary embodiments of the invention to form photoluminescent elements that can be attached to animal collars. In FIG. 3, the photoluminescent sheet material (30) is depicted as having a plurality of layers including a first (base) layer (31), a second photoluminescent layer (32) and a protective layer (33). The base layer (31) may be formed of any suitable thin flexible material such as vinyl or other materials used for making flexible and pliable photoluminescent films or sheet material. The photoluminescent layer (32) may be a layer of photoluminescent material that is either coated on the base layer (31) or integrally formed as part of, and embedded in, a top layer of the base layer (31), as is known in the art. For instance, the photoluminescent layer (32) may be formed of strontium aluminate polymer inorganic compounds, zinc sulphide compounds, or other suitable materials or compounds that can be incorporated into, or coated on, the surface of thin, flexible plastic or vinyl films. The protective coating (33) can be any suitable material (clear coat layer) that provides protection from environmental factors, such as abrasive materials, moisture, oils, and/or acidic or alkaline materials, for example.

It is to be understood that the photoluminescent material described in FIG. 3 is an example of one type of photoluminescent material that can be used to form photoluminescent elements that can be stitchably attached to animal collars according to embodiments of the invention. Various types of thin, flexible photoluminescent films or materials that are commercially available (such as photoluminescent vinyl films or sheets) can be used to form photoluminescent elements for constructing glow-in-the-dark animal collars in accordance with exemplary embodiments of the invention. In particular, various types of photoluminescent vinyl products that are commercially available, may be used to form photoluminescent elements. Such vinyl films are currently offered in various colors (green, yellow, blue, red, etc.) and designed with varying degree of luminescence characteristic that provide visibility from 18 to 38 hours, for example.

As noted above, it is to be appreciated that animal collars can be equipped with photoluminescent elements in the form of strips, patches, or other ornamental shapes, which are stitchably secured to the collar straps. For instance, FIG. 4 illustrates an exemplary arrangement (40) of photoluminescent elements (41˜44) which can secured to the surface of an animal collar, according to an exemplary embodiment of the invention. The photoluminsent element arrangement (40) includes a plurality of patch elements (41, 42,43, and 44) that can be spaced apart and individually stitched at desired locations along the length of the collar strap. The arrangement (40) may be such that each separate element (41˜44) is a different color, such as blue, red, yellow, green, etc., providing a sequence of glowing elements in different colors. Although the various elements (41˜44) are depicted as patch-shaped elements, the photoluminescent elements can be formed into other shapes such as circles, ovals, stars, diamonds, etc. having the same or varying glowing colors.

In other exemplary embodiments of the invention, such as shown in FIG. 5, a photoluminescent element (50) may be an elongated strip-shaped element (51) with a textual marking or pattern (52) that is printed on the surface of the strip (51) or otherwise patterned into the photoluminescent strip (51) having a non-luminescent backing. As shown in FIG. 5, the name of a pet, e.g., “SAMMY”, can be printed/patterned on/into the strip (51) for decorative purposes, wherein the marking is visible in the glowing background of the photoluminescent element (50). The markings or text print (52) can be formed by laser printing or using ink coating on photoluminescent elements that are formed from printable sheet material. For non-printable photoluminescent sheets or film material, the text pattern can be etched into into the strip (50) to remove the photoluminescent layer and form the non-glowing pattern.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

I claim:

1. An animal collar, comprising:
an elongated strap member; and
a photoluminescent element formed from thin flexible material, which is stitchably secured to a surface of the elongated strap member using a stitching pattern that comprises perimeter stitching lines that extend along a perimeter region of the photoluminescent element and a plurality of inner stitching lines that extend in an inner region of the photoluminescent element surrounded by the perimeter stitching lines.

2. The animal collar of claim 1, wherein the photoluminescent element is an elongated rectangular strip that extends over at least one half of a length of the elongated strap member.

3. The animal collar of claim 1, wherein the inner stitching lines include a plurality of straight stitching lines that extend in parallel and equidistant to each other over the inner surface region of the photoluminescent element between perimeter stitching lines.

4. The animal collar of claim 1, wherein the inner stitching lines include a plurality of parallel stitching lines that longitudinally extend between perimeter stitching lines of the photoluminescent element in a length direction of the elongated strap member.

5. The animal collar of claim 4, wherein the parallel stitching lines are spaced apart in a range of about 3/16″ to about 1/16″.

6. The animal collar of claim 1, wherein the inner stitching lines include a plurality of parallel stitching lines that longitudinally extend between perimeter stitching lines of the photoluminescent element at an angle relative to a length direction of the elongated strap member.

7. The animal collar of claim 1, wherein the inner stitching lines include a plurality of parallel stitching lines that extend between perimeter stitching lines of the photoluminescent element in a direction transverse to the longitudinal length direction of the elongated strap member.

8. The animal collar of claim 1, wherein the elongated strap member is made of leather.

9. The animal collar of claim 1, wherein the elongated strap member is made of nylon.

10. The animal collar of claim 1, wherein the elongated strap is made of plastic.

11. The animal collar of claim 1, wherein the photoluminescent element is formed from photoluminescent vinyl.

12. The animal collar of claim 1, wherein the photoluminescent element is formed from photoluminescent material that can glow for at least 18 hours.
